(19) United States
(12) Patent Application Publication
(10) Pub. No.: US 2006/0141125 A1
(43) Pub. Date: Jun. 29, 2006

(54) Meat analogue of authentic appearance

(75) Inventor: Catriona Gifford, Wodonga (AU)

Correspondence Address: FULBRIGHT & JAWORSKI, LLP, 1301 MCKINNEY, SUITE 5100, HOUSTON, TX, 77010-3095, US

(73) Assignee: Mars Incorporated, McLean, VA (US)

(21) Appl. No.: 10/535,121

(22) PCT Filed: Nov. 18, 2003
(86) PCT No.: PCT/AU03/01541

§ 371 Date: Jan. 27, 2006

(30) Foreign Application Priority Data
Nov. 18, 2002 (AU) 2002952721

(51) Int. Cl. A23J 1/00

(52) U.S. Cl. 426/656

(57) ABSTRACT

Disclosed is a proteinaceous meat analogue, for incorporation into packaged pet foods, wherein said meat analogue consists of particles of internally texturised, proteinaceous extrudate material dispersed in a gelled matrix composed of ground meat-based and cereal-based materials; wherein the moisture content of said extrudate and said matrix are different; and wherein the internal texturisation of said extrudate has a fibrous structure. Also disclosed is a method of preparing said analogue.

### TECHNICAL FIELD

The invention relates to the field of commercial pet food manufacture. In particular it relates to a protein based material that may be used to represent an authentic meat-like chunk in packaged pet food of the type filled in cans, trays and the like rigid and semi-rigid containers, and a method of manufacturing same.

### BACKGROUND OF THE INVENTION

Food manufacturers, including commercial canned pet food manufacturers, are continuously challenged to find ways to present an appetizing and authentic food product at minimized raw material costs. One area of particular endeavour has been the goal of producing attractive meat-based products from low-grade meat by-products.

The most basic attempts to produce a meat-like ‘chunk’, or ‘meat analogue’ have involved the fine grinding of meat by-products such as liver, lungs and other trims obtained from commercial slaughter operations, with cereals and other binders, followed by heat setting. The heat-set material may then be cut into desired shapes, such as cubes, and mixed into the canned food product. Such techniques are very well known in the pet food manufacturing art, and continue to be successfully used for many high volume-selling canned pet foods.

However, for some pet food products, in particular the premium and ‘super-premium’ products, such analogues do not provide a suitable product aesthetic. These basic analogues in particular do not have the appealing ‘fibrous’ internal texture that is associated with premium muscle meat. The target for premium products is to provide an aesthetic that is as close as possible to a piece of lean steak placed in the can or tray. The traditional analogue does not provide this aesthetic.

Also, where these analogues are to be included in a canned ‘chunks in sauce’ style product, the can sterilisation process tends to cause the analogues to become further cooked, which results in the egress of cloudy protein material into the sauce, known as ‘cook-out’. This can adversely affect the color and clarity of the sauce, which presents a major aesthetic disadvantage where a relatively clear sauce is desired.

One approach that has been taken to providing a suitable analogue for premium canned pet foods is to use cereal-based extruded chunks. Such materials tend to have the desired fibrous internal texture, due to the nature of the extrusion process, and tend to be less likely to produce cook out. However, cereal-based analogues often do not have the desired innate palatability that is required of premium-branded products.

A superior meat analogue is described in WIPO Patent Document No. WO 00/69276, by Effem Foods Pty Ltd. That document discloses an extruded meat analogue of high protein content that has excellent meat-like internal texture and suitable palatability for inclusion in premium pet foods. In particular, this kind of analogue does not produce the cloudy ‘cook-out’ observed in the traditional analogues.

However, due to its high strength ex-extruder, there may be difficulties in cutting or dicing this material in a sufficiently controlled manner for it to resemble, for example, a carefully prepared diced or sliced piece of steak, if this appearance is desired. The shredded product produced by the process described in WO 00/69276 tends to display a range of sizes and shapes that would make it unsuitable for this purpose.

In addition, the outer (non-shredded) surfaces of such extruded proteinaceous products can tend to be quite smooth, which is not the typical surface expected of a piece of diced muscle meat. Therefore, this lack of authenticity also detracts from the suitability of this type of analogue for use in premium ‘chunks in sauce’ pet foods.

### BRIEF SUMMARY OF THE INVENTION

It is an object of the present invention to provide a meat analogue material that is suitable for inclusion in premium pet foods sold in cans, trays and the like containers, where a diced or sliced muscle meat aesthetic is desired.

According to one aspect of the invention, there is provided a proteinaceous meat analogue for incorporation into packaged pet foods that consists of particles of texturised, proteinaceous extrudate material dispersed in a matrix composed of ground meat-based and cereal-based materials. The inclusion of the extrudate material tends to ensure both that the cut surface of the analogue displays a ‘fibrous’ meat-like texture, due to the internal texture of the extrudate itself, and that the outer surface of the analogue displays an authentic ‘uneven’ texture, due to differential hydration of the extrudate compared with the surrounding matrix during thermal processing. An important aspect of the invention resides in employing the effect of differential hydration of the dispersed extrudate to cause the surface of the analogue to undulate, while obtaining the benefit of the fibrous internal texture of the extrudate in enhancing the fibrous ‘meat-like’ cut surface of the analogue.

Preferably, the extrudate is included in the meat and cereal matrix at between 20% and 80% by mass. Good results have been observed at inclusion rates of between 35% and 45% by mass, although further fine tuning may allow lower inclusion rates of the process for commercial scale operation.

The extrudate pieces may be included at any desired size that still provides a discernable fibrous texture to the cut surface of the analogue. Best results have been observed with extrudate pieces of average cross sectional diameter in the range 5 mm-80 mm for chunks that are to be used in super-premium pet food analogues. Suitable extrudate sizes may readily be selected for other desired analogue sizes and shapes.

Advantageously, the extrudate is a high-moisture extruded material including about 40 to 95% by weight edible proteinaceous materials selected from the group consisting of meat of bovine, ovine or other extraction, predetermined mixtures of defatted soy flour, soy meal, soy concentrate, cereal gluten in vital or starch-containing form and egg white; and up to about 7% by weight of edible mineral binding and cross-linking compounds. Especially advantageously, the extrudate should conform to the composition and manufacture described in WO 00/69276. This type of extrudate material has been found to provide an excellent internal texture to the analogue, is palatable and tends not to cause ‘cook-out’ cloudiness in the canned product sauce.

A preferred composition (by mass) of the analogue is: 35-60% high-moisture extruded material, as described above; 5-15% ground or diced muscle meat derived from animals of the group comprising ovines, bovines and porcines; 8-50% ground meat derived from poultry; 8-25% ground liver or pluck (which may contain liver, heart and lungs) derived from animals of the group comprising ovines, bovines and porcines; 2-10% binding materials; 1-7% cereal; 0.1-5% flavors and colors and 7-30% water.

In another aspect, the invention provides a prepared commercial canned, trayed, pouched or similarly packaged pet food that includes a proteinaceous meat analogue that consists of particles of texturised, proteinaceous extrudate material dispersed in a matrix composed of ground meat-based and cereal-based materials.

In a further aspect, the invention provides a method of manufacturing a proteinaceous meat analogue, consisting of particles of texturised, proteinaceous extrudate material dispersed in a matrix composed of ground meat-based and cereal-based materials, including the steps of:

preparing a paste including comminuted meat material, cereal and binder materials;

blending this paste with particles of texturised, proteinaceous extrudate material;

thermally processing this blend of materials to cause the paste to set, thereby encapsulating the extrudate material; and

cutting the thermally set analogue material to desired size and shape for inclusion in pet food products.

In a step alternative to or in partial replacement thereof, the paste may be set using other than purely thermal processing. Binding of the paste ingredients may be effected using suitable gels and starches. Starches may be used which require lower temperature ranges as would be present utilizing thermal setting techniques alone.

It will be apparent to those familiar with the art that the process described above may be embodied either as a batch or continuous process.

The nature of the invention will be further explained using a specific, non-limiting example of a meat analogue material displaying a good resemblance to a slice of muscle meat according to the invention.

### BRIEF DESCRIPTION OF THE DRAWINGS

FIG. 1 is a schematic flow diagram of a process for preparing a proteinaceous meat analogue according to the invention.

### DETAILED DESCRIPTION OF THE INVENTION

A beef steak analogue product according to the invention was prepared. The overall formulation of the product is given in Table 1.

TABLE 1

| Ingredient | mass % |
|---|---|
| Fibrous Proteinaceous Extruded Chunk | 40 |
| Mechanically De-boned Chicken Meat (MDM) | Approx. 50 |
| Binders | 3 |
| Water | 7 |
| Red Iron Oxide | 0.02 |

The fibrous extruded material was obtained as per the formulation and process described in WO 00/69276. For the present application, it was shredded to an approximate size corresponding to the ranges: height range from 0.5-10 mm, width range from 5-30 mm, length range from 20-80 mm.

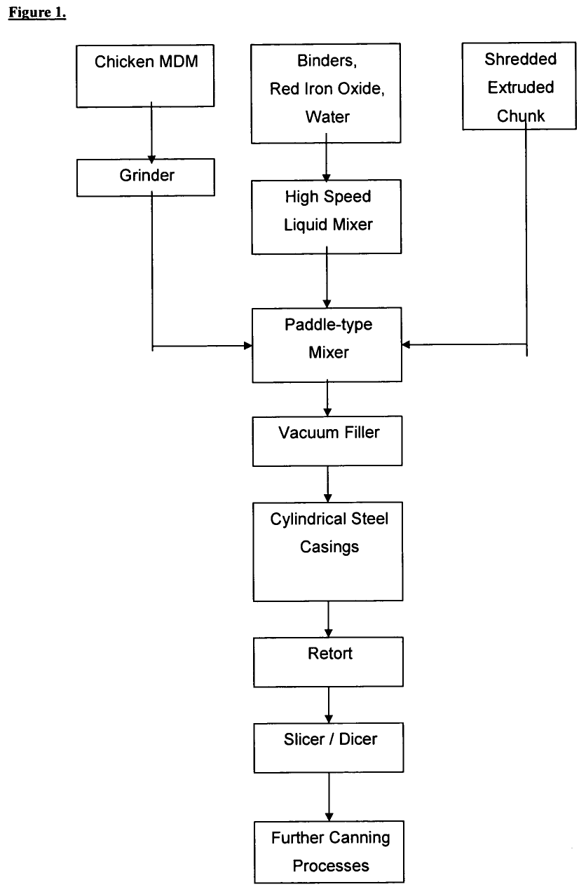

The analogue was prepared according to the process flow shown in FIG. 1. Firstly the water, binders and red iron oxide are mixed in a high speed liquid mixer. The binders serve to hold the structure of the analogue together while the red iron oxide provides authentic color to the analogue. The chicken MDM was ground in a Weiler-type meat grinder having hole plate sizes in the range 2-10 mm.

Then the mixed liquid, the ground meats and the extruded material are transferred to a horizontal paddle blender and mixed until relatively homogeneous.

This mixture is then filled into steel tubes, preferably having an internal diameter of about 50 mm. It will be appreciated by those skilled in the art that any desirable shape and diameter may be used. The filling is accomplished via a vacuum filler of the type commonly used in small goods manufacturing. The filled and sealed casings are placed on retort’ racks and thermally processed in a retort at a temperature of 95° C. for approximately 60 minutes. The thermal processing causes the protein matrix present in the mix to denature and thereby bind the extruded chunk. The thermal processing also tends to reduce the likelihood that further material will be expressed by the analogue as it is further thermally processed during the sterilization of the canned products in which it is to be included, causing ‘cook-out’ cloudiness in the sauce.

After thermal processing, and optional chilled storage, the casing is removed and the ‘sausage’ of analogue material may be cut to appropriate sizes and shapes for inclusion in canned pet food products. The cut surface of the analogue displays a fibrous ‘meaty’ appearance desired in premium pet food products, while the outer surface of the ‘sausage’ displays a relatively undulating texture similar to that displayed by cooked meat such as steak. This surface enhances the authenticity of the analogue appearance, avoiding the artificially smooth appearance of an analogue composed only of comminuted meat. The presence of evenly but randomly distributed chunks of extruded material in the analogue contributes to the controlled but visible unevenness of the analogue surface.

It will be appreciated by those skilled in the art that the above described embodiment is merely one of a multitude of ways in which the invention can be put into practical effect. For example, varied specific compositions of the extruded material, and of the analogue as a whole, may be used.

1. A proteinaceous meat analogue, for incorporation into packaged pet foods, wherein said meat analogue of comprises:
particles of internally texturised, proteinaceous extrudate material dispersed in a gelled matrix composed of ground meat-based and cereal-based materials;
wherein the moisture content of said extrudate and said matrix are different; and
the internal texturisation of said extrudate has a fibrous structure.

2. The proteinaceous meat analogue of claim 1, wherein said extrudate material is included in the meat and cereal matrix at between 20% and 80% by mass.

3. The proteinaceous meat analogue of claim 2, wherein said extrudate material is included in the meat and cereal matrix at between 35% and 45% by mass.

4. The proteinaceous meat analogue of claim 1, wherein said extrudate material has a cross sectional diameter in the range 5 mm-80 mm.

5. The proteinaceous meat analogue of claim 1, wherein the extrudate material comprises:
about 40 to 95% by weight edible proteinaceous materials selected from the group consisting of bovine, ovine, porcine, avian and ichthyoid extraction,
predetermined mixtures of defatted soy flour, soy meal, soy concentrate, cereal gluten in vital or starch-containing form and egg white; and
up to about 7% by weight of edible mineral binding and cross-linking compounds.

6. The proteinaceous meat analogue of claim 5, wherein the extrudate material comprises:
about 40-55% by mass defatted soy flour, soy meal or soy concentrate;
about 35-45% by mass vital wheat gluten, egg white powder, a mixture of vital wheat gluten and maize gluten or a mixture of vital wheat gluten and wheat flour;
0.1-7.0% by mass of non-leaching mineral compounds for binding the protein matrix and for enhancing protein cross-linking;
0-5% by mass nutritional fiber additives;
0.1-0.3% by mass vitamins;
0-3.0% by mass flavoring agents; and
0-3.0% by mass coloring agents.

7. The proteinaceous meat analogue of claim 1, wherein the composition (by mass) of the analogue is:
35-60% high-moisture extruded material;
5-15% ground or diced muscle meat derived from one or more animals selected from the group comprising ovines, bovines and porcines;
8-50% ground meat derived from poultry;
8-25% ground organs selected from the group comprising liver, heart and lungs, said organs being derived from one or more animals of the group comprising ovines, bovines and porcines;
2-10% binding materials;
1-7% cereal;
0.1-5% flavors and colorsA and
7-30% water.

8. A prepared commercial canned, trayed, pouched or similarly packaged pet food, said pet food including a proteinaceous meat analogue the analogue comprising:
particles of internally texturised proteinaceous extrudate material dispersed in a gelled matrix composed of ground meat-based and cereal-based materials;
wherein the moisture content of said extrudate and said matrix are different; and
the internal texturisation of said extrudate has a fibrous structure.

9. A method of manufacturing a proteinaceous meat analogue, consisting of particles of texturised, proteinaceous extrudate material dispersed in a matrix composed of ground meat-based and cereal-based materials, comprising the steps of:
preparing a paste including comminuted meat material, cereal and binder materials;
blending said paste with particles of texturised, proteinaceous extrudate material;
processing this blend of materials to cause the paste to set, thereby encapsulating the extrudate material; and
cutting the set analogue material to desired size and shape for inclusion in said pet food products.

10. The method of claim 9, wherein the processing step includes thermal processing.

11. The method of claim 10, wherein the processing step includes filling said blend in solid casings and retorting at 95° C.

12. The method of claim 11, wherein the solid casings have rectangular cross-section of dimensions of about 50 mm by 100 mm and said casings are heated at 95° C. for about 60 minutes.

13. The method of claim 9, wherein said set analogue is cut to dimensions of about 48 mm by 22 mm by 5 mm.

14. The proteinaceous meat analogue of claim 6, wherein the nutritional fiber additives are cellulose or beet pulp;
